(19) United States
(12) Patent Application Publication
(10) Pub. No.: US 2020/0387266 A1
(43) Pub. Date: Dec. 10, 2020

(54) ELECTRONIC ORDERING OF MENU ITEMS

(71) Applicant: Ehimwenma Osakpolo H AKINLADE, Leeds (GB)

(72) Inventor: Ehimwenma Osakpolo H AKINLADE, Leeds (GB)

(21) Appl. No.: 16/890,305

(22) Filed: Jun. 2, 2020

(30) Foreign Application Priority Data
Jun. 4, 2019 (GB) 1907948.2

(51) Int. Cl. G06F 3/0482; G06Q 50/12; G06Q 30/06; G06Q 30/02; G06F 16/951

(52) U.S. Cl. CPC G06F 3/0482; G06Q 50/12; G06F 16/951; G06Q 30/0201; G06Q 30/0633; G06Q 30/0631

(57) ABSTRACT

A method of operating an electronic device is provided, the method comprising: registering a new venue; and associating a starter menu to the registered venue; wherein the starter menu comprises at least one menu item selected from a master menu according to at least one predetermined condition, the master menu comprising menu items included in at least one menu associated with at least one other registered venue.

### CROSS-REFERENCE TO RELATED APPLICATIONS

This application claims the benefit under 35 U.S.C. 119(a) to Great Britain Application No. 1907948.2, filed 4 Jun. 2019, the disclosure of which is incorporated herein by reference in its entirety.

### SUMMARY

This invention relates to apparatus and methods for electronic ordering of menu items in venues serving beverages and/or food.

### BACKGROUND

Smart devices, such as smart phones, are now considered ubiquitous and are already present in numerous applications. These devices possess a great potential for use in the nightlife industry. One such application is to the process of ordering beverages in nightclubs and bars. These transactions previously hinged on a physical interaction. Utilising smart devices to receive and process orders, bartenders can be freed from the point of sale and can instead focus on the core of their craft: making high quality beverages. Such a solution has the added benefits of increasing productivity for the venue by accelerating turnover and reducing waiting for the customer. However, existing solutions are typically confined to a single venue or chain of venues. These solutions are inconvenient for consumers and venue owners, requiring a lengthy and resource-intensive setup process.

### BRIEF SUMMARY OF THE DISCLOSURE

It is an aim of certain embodiments of the invention to solve, mitigate or obviate, at least partly, at least one of the problems and/or disadvantages associated with the prior art. Certain embodiments aim to provide at least one of the advantages described below.

An aspect of the invention provides a method of operating an electronic device, the method comprising: registering a new venue; and associating a starter menu to the registered venue; wherein the starter menu comprises at least one menu item selected from a master menu according to at least one predetermined condition, the master menu comprising menu items included in at least one menu associated with at least one other registered venue.

Another aspect of the invention provides a method of operating an electronic device, the method comprising: receiving a user input selecting one or more menu items to be ordered; and adding an order comprising the menu items to be ordered to a pending order stream.

Another aspect of the invention provides a method of operating an electronic device, the method comprising: receiving a user input to change the status of an order in a pending order stream; and updating the order status.

Another aspect of the invention provides a computer program comprising instructions arranged, when executed, to implement a method in accordance with any one of the above-described aspects. A further aspect provides machine-readable storage storing such a program.

Another aspect of the invention provides an electronic device configured to: register a new venue; and associate a starter menu to the registered venue; wherein the starter menu comprises at least one menu item selected from a master menu according to at least one predetermined condition, the master menu comprising menu items included in at least one menu associated with at least one other registered venue.

Another aspect of the invention provides an electronic device configured to: receive a user input selecting one or more menu items to be ordered; and add an order comprising the menu items to be ordered to a pending order stream.

Another aspect of the invention provides an electronic device configured to: receive a user input to change the status of an order in a pending order stream; and update the order status.

### BRIEF DESCRIPTION OF THE DRAWINGS

Embodiments of the invention are further described hereinafter with reference to the accompanying drawings, in which:

FIG. 1A illustrates a system according to an example of the disclosure;

FIG. 1B illustrates an electronic device according to an example of the disclosure;

FIG. 1C illustrates an electronic device according to an example of the disclosure;

FIG. 2 illustrates a method according to an example of the disclosure;

FIG. 3 illustrates a system flow according to an example of the disclosure;

FIG. 4 illustrates a method according to an example of the disclosure;

FIGS. 5A and 5B illustrate screens that may be displayed on a venue manager's device according to an example of the disclosure;

FIGS. 6A to 6D illustrate screens that may be displayed on a customer's device according to an example of the disclosure;

FIG. 7 illustrates a process flow for placing and processing an order according to an example of the disclosure; and

FIGS. 8A and 8B illustrate example screens that may be displayed on a staff member's device according to an example of the disclosure.

### DETAILED DESCRIPTION

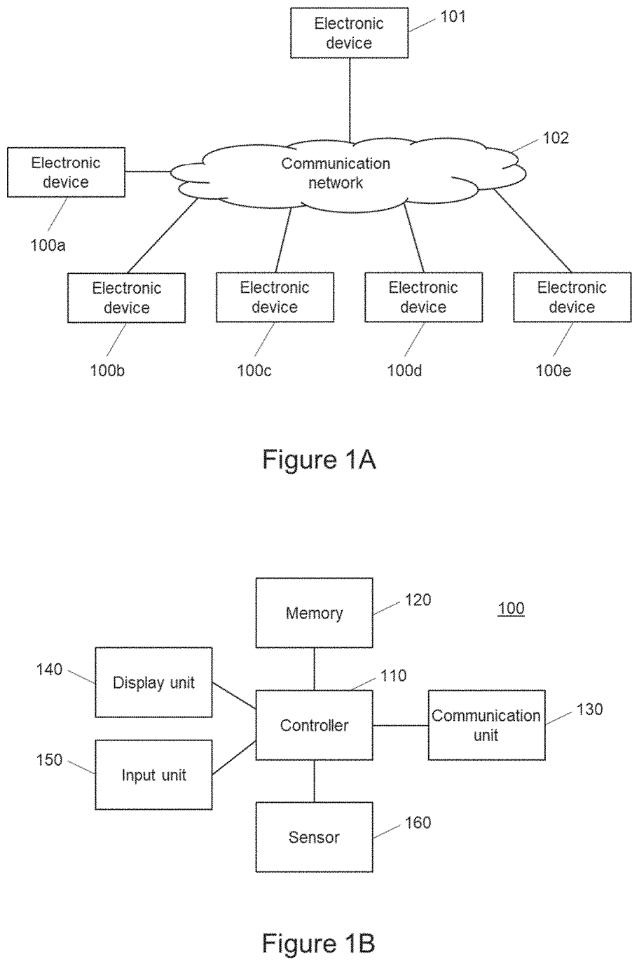

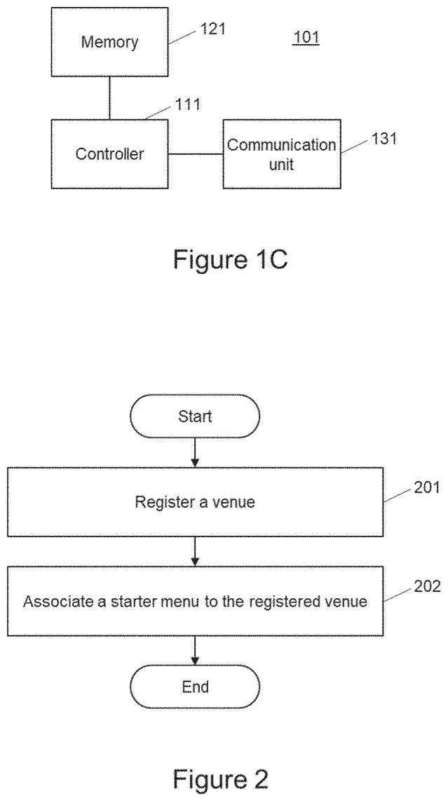

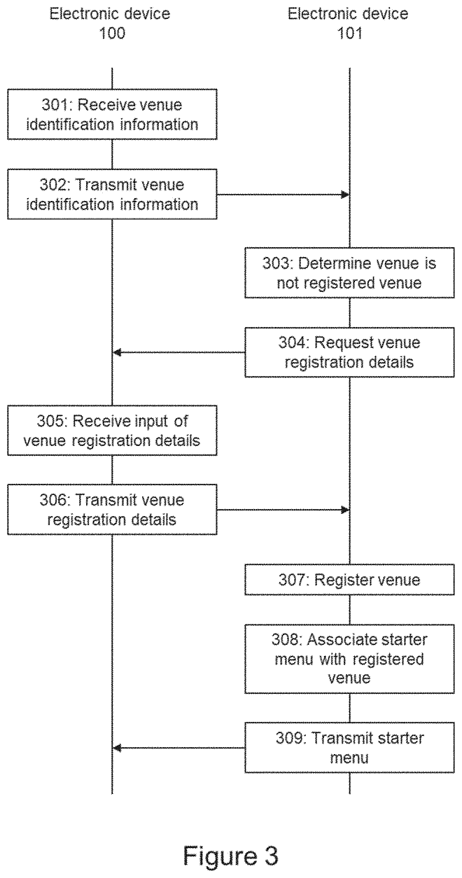

FIG. 1A illustrates a system according to an example of the disclosure that may be used to implement the methods described herein. The system may comprise a plurality of electronic devices 100a, 100b, 100c, 100d, and 100e, and an electronic device 101. The electronic devices 100a-100e are connected to the electronic device 101 by a communication network 102. The communication network 102 may be any suitable network, such as a local area network (LAN), wide area network (WAN), wireless network, wired network, cellular network, internet etc. In some embodiments the electronic device 101 may be server, for example a cloud server, but it will be appreciated that the electronic device 101 may be any suitable electronic device. In some embodiments, the electronic devices 100a-100e may be mobile devices, such as smart phones, wearable devices, tablets, or laptop computers, but it will be appreciated that electronic devices 100a-100e may be any suitable electronic devices in any combination. Furthermore, it will be appreciated that the system is not limited to any particular number of electronic devices.

Each electronic device 100a-100e may install and run an application for processing menu orders. The system for may comprise one or more electronic devices 100a-100e configured to run the application that integrates with an electronic device 101 (e.g. a remote server) on a communications/cloud network to present multiple user interfaces within a single modular environment, with which a first user type (e.g. an industry user such as a staff member or venue manager), is able to set up a menu and accept, receive payment for, and dispense orders made by a second user type (e.g. customers) at any particular venue.

The application may support different user types. For example, electronic device 100a may belong to a venue manager, electronic devices 100b and 100c may belong to staff and electronic devices 100d and 100e may belong to customers. It will be appreciated that this is merely exemplary, and that the system may comprise any number of electronic devices with any combination of user types. Furthermore, an electronic device may belong to more than one user and a user may have more than one user type. For example, a electronic device may belong to an individual that uses the application as staff (e.g. a bartender) in one venue (i.e. their workplace) and as a customer in other venues.

The user type may be determined by user selection at initial running or installation of the application and the application flow may be directed according to the selection. Users representing a venue manager or staff may be classed as “industry” users, and upon initial use or installation of the application, may register the venue with the operating electronic device as a primary/master device, provide a payment receipt account, and create an access code to enable multiple staff members operating the application on individual electronic devices to process and dispense orders autonomously.

When installing the application or executing the application for the first time a user may create an account. The account may be assigned a unique identifier, which may be a unique device identifier taken from the user's electronic device 100. The user may select one or more user types for the account. The user type may be stored as a constant and may be used to determine the particular application user interface that is presented to the user. When logging into the application, the account details of the user may be used to identify the user type, or in the case where the user account has multiple types, the user may be requested to select the current user type. User types may include venue manager, staff, and customer. For example, the methods described herein may further comprise identifying a type of a user as a venue manager, a staff member, or a customer. A user account may be associated with a plurality of venues. For example, a venue manager may manage multiple venues, a staff member may work at multiple venues, and a customer may place orders at multiple venues. The system and application thus provide a single platform that may be used by a plurality of independent venues for allowing orders to be placed and processed.

The user type may affect the functions that are available to the user. For example, a venue manager may have access to all functions of the application. A staff-type user may not have access to some or all venue and/or menu setup functions, such as registering a venue, editing venue details, editing the venue menu, adding menu items, editing menu items, etc. A customer may only have access to ordering and payment functions such as ordering and paying for menu items and adding gratuities.

The user type may affect the order history that is accessible to the user. That is, an order history may be accessible on a per-venue, per-staff member, or per-customer basis. For example, a venue manager may be able to access an order history of orders placed at their venue(s), a staff member may be able to access an order history of orders they have accepted (which may include orders accepted at different venues), and a customer may be able to access an order history of orders they have placed (which may include orders placed at different venues).

Although a single application that presents different user interfaces to different user types is described, it will be appreciated that the methods described herein could be implemented using separate applications for different user types. For example, there may be an industry application for industry users and a customer application for customers. Each user may install the appropriate application on their electronic device 100, and electronic device 101 may be configured to receive and process inputs and outputs for each type of application. In some embodiments, there may be a single application comprising different modules for different user types. For example, installation of the application may comprise a core module configured to determine a user type and download and install additional modules appropriate for the determined user type. For example, if the user is determined to be a customer, an ordering module may be downloaded and installed, whereas if the user is determined to be a venue manager, all available modules may be downloaded and installed.

A primary device when first registering the venue may be furnished with a customisable starter menu comprising a selection of menu items (e.g. beverages, food, etc.), determined by functions based upon existing data for individual menu item sales and incidence, that may be stored on a centralised master database, or master menu. The master menu may be stored and managed at electronic device 101. As prices or descriptions of menu items will vary across multiple venues, venue managers may have multiple options to create or customise their starter menu. For example: menu items not present in the starter menu but sold by the venue may be added by using photographic barcode scanning (utilising the operating electronic device's built-in camera) or by manual input, which may utilise text auto-complete functions to streamline the entering of data. Any new menu item to be added may first be checked for prior existence within the centralised master database, which may be fiducial with respect to the venue's customised menu, ensuring only new menu items are added to each.

Once a venue manager has created a venue menu and provided payment information, the application will be ready to accept customer orders at the venue and may allow venue staff to process orders. The venue menu may be presented for selection of menu items to order by customers using the application on their personal electronic devices. The venue may advertise its affiliation with the application platform to its customers so that they may be aware that they can order menu items using the application.

Customers may be the second user type and by using the application customers may be able to log into and order from any venue that is operating the platform (i.e. any registered venue). A customer may be able to receive remote notification, for example by SMS messaging or their electronic device's native notification system, on the current status of their order, or track the status of their order through a section of the application user interface called the stream or “Pour”.

When an order is placed by a customer, a request may be sent by the customer's device to an electronic device, which may be a remote server hosted at a private domain/IP address. During this request the order may be logged as received and given a unique identifier and order number. Order details and status may be stored in the order database, and the master menu and venue menu sale statistics may be updated accordingly when the order is paid. Once the order is marked as collected, the order may be removed from the venue's stream and the order ID may be logged in an order history.

Staff signed in to dispense for a venue may watch the stream as new orders are received. From the stream, staff may select and view an order and may choose to accept or reject the order. Individual menu items may be marked as out of stock, which may force a temporary removal or “freezing” of the selection of that particular menu item, preventing future requests for any menu item that is out of stock.

The platform's architecture is designed to explore the possibilities of the concept of freelance staff and may add an extra element of personalisation and utility to staff. Staff may be enabled by the platform to keep a record of the provision of their services to multiple venues and may set up a customisable profile to display their names and other chosen information to users, allowing customers to see who is preparing their menu item and to include tips/gratuities. Staff may be enabled to create their own personalised user menu for any menu items (e.g. cocktails) they have a speciality in making, that may be viewed at the venue they are dispensing for on that occasion. Order histories may also be managed and statistics on sales made may be exposed for presentation in some format within the application.

Part of the application infrastructure is the centralised menu database from which customised menus, specific to each venue, may be drawn and edited. This format enables venue managers to quickly and easily set up a menu for their venue from which customers may order. The application may increase the ease with which new affiliates are able to set up their venue and menu for electronic ordering.

FIG. 1B illustrates an electronic device 100 according to an example of the disclosure, that may be used to implement the methods described herein. For example the electronic device 100 may be any of the electronic devices 100a-100e described above.

As illustrated in FIG. 1B, the electronic device 100 may comprise a controller 110, a memory 120, a communication unit 130, a display unit 140, and an input unit 150. The memory 120 may be configured to store the application and associated data. For example, the memory 120 may be configured to store the master menu, registered venues, venue menus, venue details, user accounts, user details, payment details, order data, etc. The controller 110 may be configured to control the electronic device 100 to execute the application. That is, controller 110 may be configured to control the components of electronic device 100 to perform the methods described herein. The communication unit 130 may be configured to transmit and receive signals in order to perform the methods described herein. For example, the communication unit 130 may be configured to communicate with the electronic device 101 via the communication network 102. The display unit 140 may be configured to display the application. The input unit 150 may be configured to receive a user input. For example, the input unit may comprise a touch pad. The input unit 150 and display unit 140 may be combined in the form of a touch screen.

The electronic device 100 may also comprise at least one sensor 160. The at least one sensor may comprise an image sensor configured to capture image data. For example, the image sensor may be a camera. The at least one sensor may also comprise a location sensor configured to detect information that may be used to identify a location of the electronic device 100. For example, the location sensor may comprise a GPS sensor.

Although the application is described above as being stored on a memory 120 of the electronic device 100 and executed by the controller of the electronic device 100, it will be appreciated that some or all of the application processes and method steps described herein may be executed wholly or partially on a different device, for example on the electronic device 101. In some embodiments, all processing may be performed at the electronic device 101, and electronic device 100 may function as a ‘dumb’ terminal for displaying the user interface and receiving user inputs only.

FIG. 1C illustrates an electronic device 101 according to an example of the disclosure that may be used to implement the methods described herein. The electronic device 101 may comprise a controller 111, a memory 121, and a communication unit 131. The memory 121 may be configured to store the application and data associated with the application. For example, the memory 121 may be configured to store the master menu, registered venues, venue menus, venue details, user accounts, user details, payment details, order data, etc. The controller 111 may be configured to control the components of electronic device 101 to execute the application and perform the methods described herein. The communication unit 131 may be configured to transmit and receive signals in order to perform the methods described herein. For example, the communication unit 131 may be configured to communicate with the electronic device 100 via the communication network 102.

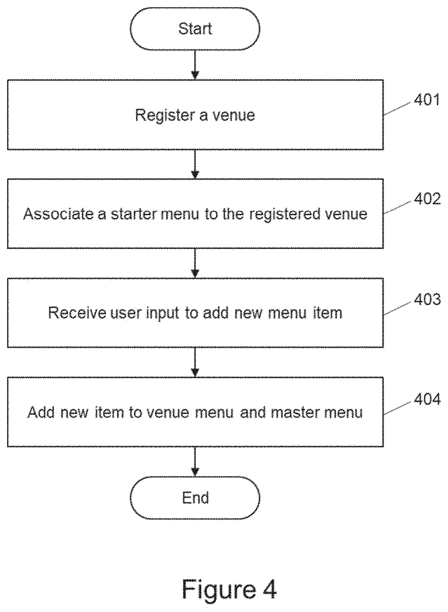

FIG. 2 illustrates a method of operating electronic device 101 according to an example of the disclosure.

In step 201 a venue is registered. For example, a venue may be stored in a database of previously registered venues. Details of the venue, such as name, address, location information (e.g. GPS coordinates), opening hours, venue type/theme, and any other suitable details may be input by a user (e.g. a venue manager) and stored in the database. A unique identifier may be assigned to the venue as part of the registration process. Registering the venue may comprise providing and verifying a payment option to enable receipt of customer payments. The payment details may be stored in the database.

In step 202 a starter menu is associated to the registered venue. The starter menu may comprise at least one menu item selected from a master menu according to at least one predetermined condition. That is, the master menu may comprise a set of menu items and the starter menu may comprise a subset of that set, wherein the menu items in the subset satisfy at least one predetermined condition. The starter menu may be referred to as an initial menu or default menu for the newly registered venue. Once associated with the newly registered venue, the starter menu may be referred to as the menu associated with the registered venue, or as the venue menu.

The at least one predetermined condition may comprise conditions based on data collected from other registered venues, for example number of sales in other registered venues, frequency of inclusion in menus associated with other registered venues, and profitability in other registered venues. Such conditions could be filtered based on venue details associated with registered venues such as the type of venue (e.g. bar, restaurant, cafe), theme of the venue (based on the type of food served or music played for example), etc. For example, a filtered conditions might be number of sales in other registered venues of the same type and/or theme as the newly registered venue. It will be appreciated that the same data and venue details may be available from other venues that are not registered, for example industry reports and publicly accessible venue menus and venue details (for example on individual venue websites or general venue websites/databases, such as venue review websites), and that the condition may alternatively be based on such external data.

That is the condition may comprise number of sales in other venues, frequency of inclusion in menus associated with other venues, or profitability in other venues, for example. The conditions may also be based on other details of menu items, such as ingredients, allergens, price, manufacturer, origin, etc. The user (e.g. a venue manager) may be able to select one or more conditions and filters to generate a customized starter menu. For example, a venue manager of a venue aiming to specialise in serving obscure gin-based drinks may select ingredient=gin and frequency=low as conditions to generate a starter menu comprising gin-based drinks that are rarely included in menus of other venues. As another example, a venue manager of an Indian restaurant may select theme=lndian, type=restaurant, and sales=high to generate a starter menu of menu items that have high sales in other Indian restaurants.

The master menu may comprise menu items included in at least one menu associated with at least one other registered venue. That is, each registered venue may have an associated menu (i.e. a venue menu) comprising menu items, and the master menu may comprise any menu item included on any individual venue menu. Whenever a menu item is added to a menu associated with a venue, that menu item may be added to the master menu. The master menu may be stored at the electronic device 101.

The method may further comprise identifying a venue. For example, the venue may be identified using a location database and current location data (e.g. GPS coordinates) of an electronic device 100 implementing the method, or may be identified by user input of one or more venue details (e.g. venue name, address, a unique identifier assigned to the venue, etc.).

The method may further comprise determining if the identified venue is a registered venue. For example, a database of previously registered venues may be searched for venues matching the identified venue. The database may be stored at the electronic device 101 and/or the electronic device 100. If the venue is not a registered venue, registering a new venue may comprise registering the identified venue. That is, the method may comprise identifying a venue, determining if the identified venue is a registered venue, registering, if the identified venue is not a registered venue, the identified venue, and associating a starter menu to the registered venue.

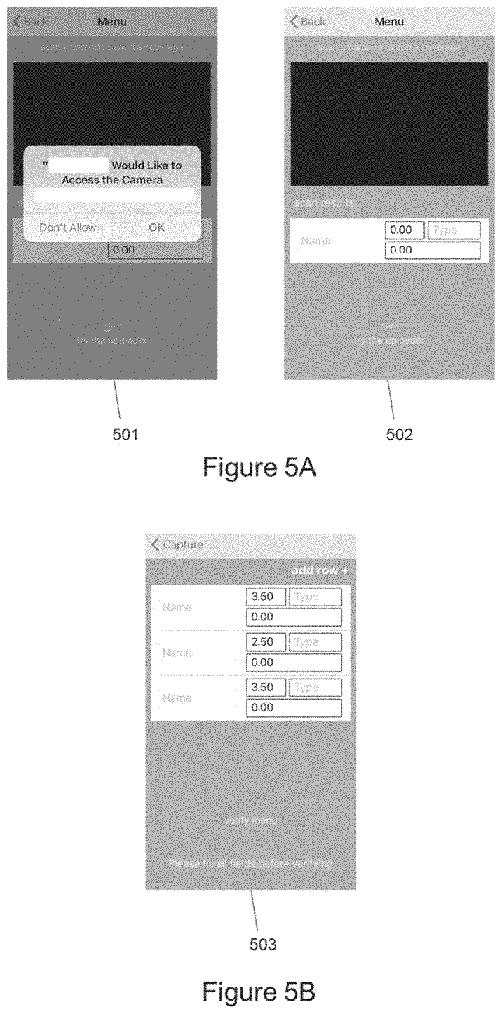

FIG. 3 illustrates a system flow according to an example of the disclosure. The illustrated system comprises the electronic device 100 and the electronic device 101.

The system first identifies a venue. At 301 the electronic device 100 may receive venue identification information such as location data or user input of venue details. The electronic device 100 may transmit the venue identification information to the electronic device 101 in step 302.

The electronic device 101 may receive the venue identification information from the electronic device 100 and determine, based on the venue identification information, whether the venue is a registered venue in step 303. For example, the electronic device 101 may search a database of previously registered venues for venues matching the identified venue. If multiple registered venues match the identified venue, the electronic device 101 may send a list of the matching venues to the electronic device 100 for the user to select from.

If the venue is not a registered venue, the system may perform venue registration. The electronic device 101 may transmit a request for venue registration details to the electronic device 100 in step 304. The electronic device 100 may receive user input (e.g. by a venue manager) of venue registration details in step 305 and transmit the venue registration details to the electronic device 101 in step 306. The electronic device 101 may register the venue based on the venue registration details in step 307.

The electronic device 101 may then generate a starter menu comprising at least one menu item selected from a master menu according to at least one predetermined condition, and associate the starter menu with the venue in step 308.

The electronic device 101 may then transmit the starter menu to the electronic device 100 in step 309. The electronic device 100 may present the starter menu to the user for editing in step 310.

It will be appreciated that the number and separation of steps between devices in FIG. 3 are merely exemplary. For example, the electronic device 101 may instead generate a starter menu after determining that the venue is not registered in step 303, and transmit the starter menu to the electronic device 100 with the request for venue registration details. As another example, the electronic device 100 may contain a database of registered venues and may perform step 303 (determining if the venue is a registered venue). In this example, step 304 may not be performed and the electronic device 100 may directly proceed to receiving user input of venue registration details in step 305.

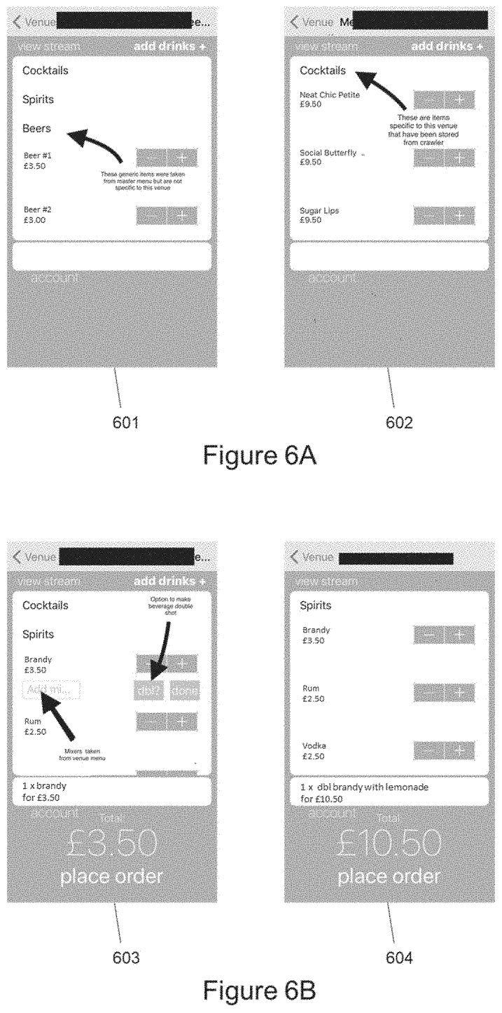

FIG. 4 illustrates a method according to an example of the disclosure. Steps 401 and 402 are the same as steps 201 and 202 in FIG. 2, respectively. After step 402, the method proceeds to step 403.

In step 403, a user input (e.g. by an industry user) to add a new menu item to the menu associated with the registered venue is received. For example, the user input may be received at the electronic device 100 and transmitted to the electronic device 101. The method then proceeds to step 404.

In step 404, the new menu item is added to the menu associated with the registered venue. The new menu item is also added to the master menu. For example, the electronic device 101 may add the new menu item to the menu associated with the venue, transmit the updated venue menu to the electronic device 100, and add the new menu item to the master menu.

Adding the new menu item to the master menu may comprise determining if the new menu item already exists on the master menu, and adding, if the new menu item does not already exist on the master menu, the new menu item to the master menu. That is, the new menu item that is added to the menu associated with the registered venue may only be added to the master menu if the new menu item is not currently included in the master menu. For example, the electronic device 101 may search the master menu for a menu item corresponding to the new menu item. This may prevent duplication of menu items on the master menu.

If the new menu item does already exist on the master menu, the user may be informed. The user may be asked if they wish to use the existing data for the new menu item on the master menu to add the new menu item to the venue menu. For example, the electronic device 101 may inform the electronic device 100 that the new menu item already exists on the master menu. The electronic device 100 may display an indication that the new menu item already exists on the master menu and a request to use the existing data from the master menu. This may further accelerate and simplify the process of setting up the venue menu.

Receiving a user input to add a new menu item to the menu associated with the venue may comprise receiving an image input. The image may be acquired by an image sensor of the electronic device 100, but may also be acquired using the communication network 102 (e.g. from the internet or from another device) or from the memory 120 of the electronic device 100. The application may use image recognition techniques to recognise a menu item from a photograph, for example by recognising packaging or other visual characteristics in a photograph of the menu item. The application may use optical character recognition (OCR) to read text in an image. For example, the image input may be an image or photograph of a menu and the application may use OCR to extract menu items from the menu image. The application may identify visual codes such as barcodes or QR codes in an image and identify a menu item based on a visual code. For example, the barcode on a bottle label may be used to identify the drink as a new menu item to be added. It will be appreciated that image recognition and menu item identification may be performed locally at the electronic device 100, remotely at a server, or any combination of these. For example, the electronic device 100 may capture an image of a barcode and read the barcode then search a remote barcode database (e.g. located on the internet or the electronic device 101) for a menu item corresponding to the barcode.

Receiving a user input to add a new menu item to the menu associated with the venue may comprise receiving text input. For example, the user may input text to an ‘add new menu item’ form or user interface element displayed by the electronic device 100. Text auto-complete functions may be used to streamline the entering of data. The user may enter a name or other identifier of the new menu item and additional details (e.g. ingredients, allergens, price, manufacturer, origin, URLs, etc.) of the menu item may be retrieved from databases (e.g. on the internet) and suggested to the user.

Receiving a user input to add a new menu item to the menu associated with the venue may comprise receiving input of a file, for example a text file or a spreadsheet file. The application may be able to recognise and extract menu items from the file.

Receiving a user input to add a new menu item to the menu associated with the venue may comprise receiving selection of menu items from a list of menu items suggested by the application. For example, when an input indicative of an intention to add a new menu item is received, the application may present a list of suggested menu items from the master menu for the user to select from or may simply present the entire master menu for the user to select from. The suggested menu items may comprise a list of menu items filtered using one or more conditions. The conditions may comprise, for example menu items with high order numbers at other registered venues, menu items frequently included on other registered venue menus, menu items with high profitability, or any other suitable conditions. From these examples it will be appreciated that the conditions may be based on data from other registered venues, such as order data, sales data, price data, menu data, etc.

The methods described herein may further comprise receiving a user selection (e.g. by an industry user) of a menu item on a menu associated with the venue, and receiving a user input to edit the menu item. For example, details of an existing menu item, such as ingredients, allergens, price, manufacturer, origin, URLs, etc. may be edited. The edited details may be confined to the venue menu, may be used to update the menu item on the master menu, or a new menu item may be added to the master menu based on the edited details. For example, an edit to the price of the menu item may be venue specific and so may not be synchronised with the master menu, an edit to the ingredients may be synchronised with the menu item on the master menu, and an edit to the manufacturer may result in a new menu item being added to the master menu. When a menu item on the master menu is updated due to a user edit, the corresponding menu item on other venue menus may be updated with the edited details. For example, the user input to edit the menu item may be received at electronic device 100 and transmitted to electronic device 101. Electronic device 101 may update the venue menu and master menu based on the user input. Editing the menu item may comprise deleting the menu item from the venue menu. Deleting the menu item from the venue menu may not remove the menu item from the master menu.

The methods described herein may comprise finding online venue menus, extracting one or more menu items from the found online venue menus, and adding the extracted menu items to the master menu. For example, the electronic device 101 may use web-crawling techniques to find venue menus accessible through the internet and may extract menu items from the found venue menus in order to expand the master menu with new menu items. The method may further comprise extracting additional information and details from the online venue menu, such as menu item prices, menu item descriptions, etc. When a new venue is registered, the methods described herein may further comprise determining if an online venue menu of the venue has previously been found. If an online venue menu of the venue has previously been found, the starter menu may include menu items extracted from the found online venue menu. For example, when finding online venue menus, a record of each found online venue menu and the corresponding venue may be stored, and when a new venue is registered the new venue details may be used to determine if an online venue menu of a venue corresponding to the newly registered venue has been stored. If an online venue menu of the venue has not previously been found, the methods may further comprise searching for an online venue menu of the venue, extracting, if an online venue menu of the venue has previously been found, one or more menu items from the found online venue menu, and adding the extracted menu items (including additional details such as prices, descriptions etc. extracted from the found online venue menu) to the starter menu. The starter menu may thus comprise menu items from the found online venue menu instead of or as well as menu items selected from the master menu according to at least one predetermined condition. The electronic device 101 may be enabled with a periodically run script in the form of a “Cron Job” or “SQL Trigger” function, or any other suitable function capable of scheduled execution of a script. The periodic execution of the script may serve as a web crawler that searches venue websites, converts their online menus to the application's data structure so as to pre-empt such a time that the venue registers with the application. It will be appreciated that such online menu harvesting could additionally or alternatively be performed manually. These techniques may further accelerate and simplify the process of setting up the venue menu.

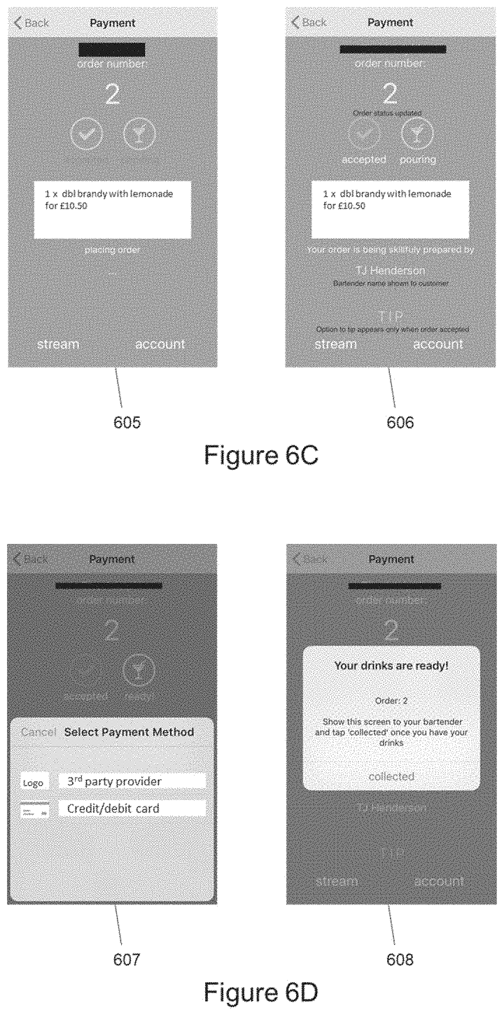

An application flow according to an example of the disclosure is now described from the perspective of a venue manager-type user. FIGS. 5A and 5B illustrate example screens that may be displayed on the venue manager's device.

The user installs and launches the application on electronic device 100 and is assigned a unique device identifier taken from electronic device 100. The user selects venue manager as their user type which is stored as a constant and is used to determine the particular application interface that is presented to the user when launching the application in future. The user's device may be marked as a primary or master device with location details saved as part of a master key. The master key may be used to ensure that only a venue manager, either from the master device or using credentials associated with master device but on another device, is able to delete items and change prices. Staff-type users without the master key may only be able to add items and not edit existing items.

The system identifies a venue, determines if the venue is a registered venue, and, if the venue is not a registered venue, registers the venue with the user as venue manager and the user's device as the primary device for the venue.

The user is then presented with starter menu for customisation. Menu item prices are initially based on a price (e.g. a recommended retail price) from the master menu and the user inputs the venue's chosen price and an optional description. The application serves the user with pre-populated editable text fields within a table supported by a runtime database that is then sent to electronic device 101 for storage. Menu items may be grouped into for categorization and enhanced menu navigability. For example beverages may be grouped into eight types: Cocktail, Beer, Cider, Wne, Champagne, Spirit, Mixer, and Misc.

The user may add new menu items to the venue menu by utilising barcode scanning protocols native to the camera capabilities of electronic device 100. For example, the user may be asked to allow the application to access the camera, as shown in screen 501 of FIG. 5A. If permission is granted, the user may be presented with screen 502 allowing the user to scan a barcode and be presented with scan results. The user may enter menu item details manually. For example, the user may be presented with screen 503 for adding menu items, as shown in FIG. 5B. The user may also edit menu items on the venue menu, which may comprise removing menu items from the venue menu.

New menu items are checked for coincidence with existing menu items within the master menu which is fiducial with respect to the venue menu.

The user provides and verifies a payment option to enable receipt of customer payments.

Following initial menu set up and payment verification, the user will be returned to the menu where further editing can be performed. Users operating the application as a venue manager or operating the application on the primary/master device may be exposed to additional customisation functions to those of a staff-type user. A venue manager may also have access to the order processing functions of a staff-type user and/or the order placing functions of a customer (e.g. for testing purposes). These functions are described below.

The methods described herein may further comprise receiving an order of a menu item selected from the menu associated with the venue, processing the order, and updating the master menu with order data associated with the order.

Receiving an order may comprise receiving a user input (e.g. from a customer) at an electronic device 100 selecting one or more menu items to be ordered. An order may comprise an order number, a unique identifier, a timestamp, the menu items included in the order, the price of the order, the user that placed the order, etc. Receiving an order may further comprise receiving a promotional code which may alter the price of the order. The promotional code may be time-limited. Receiving an order may further comprise receiving an indication that the order has a user flag or gratuity. User flags and gratuities may be manually selected by a user when placing an order or may be automatically added to a user's order according to a user account setting. For example, a user may select a user account setting to always add a 10% gratuity when they place an order.

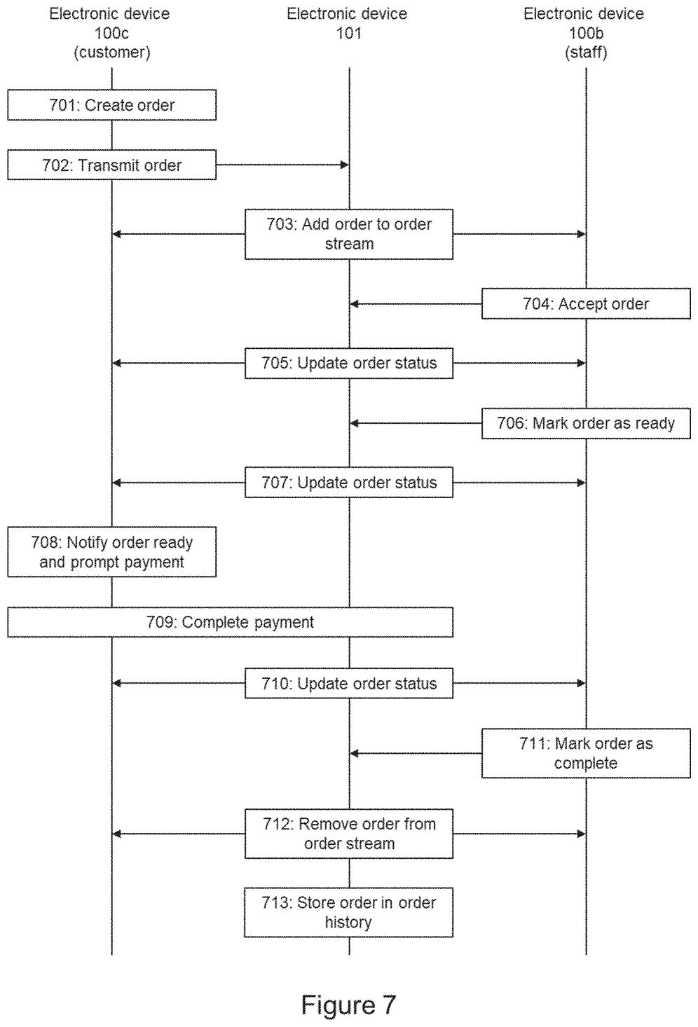

An application flow according to an example of the disclosure is now described from the perspective of a customer-type user. FIGS. 6A to 6D illustrate example screens that may be displayed on the customer's device.

The user installs and launches the application on electronic device 100 and is assigned a unique device identifier taken from electronic device 100. The user selects customer as their user type which is stored as a constant and is used to determine the particular application interface that is presented to the user when launching the application in future. The user may be prompted to set up payment details, for example by entering details of a payment card or by linking their account to a third-party payment account. When setup is complete, or when the user subsequently launches the application and logs into their account (which may be automatic if the user's login details are stored at electronic device 100) the system identifies a venue, determines if the venue is a registered venue, and presents, if the venue is a registered venue, the menu associated with the registered venue to the user on electronic device 100. For example, the system may determine the user's initial location by utilising a location service of electronic device 100, find a registered venue corresponding to the determined location, and present the registered venue to the user. The system may allow the user to select an alternative location or venue, should it differ from the suggested location or venue.

The user is presented with the menu associated with the registered venue. For example, the user may be presented with screens 601 and 602 for selecting menu items, as illustrated in FIG. 6A. Screen 601 shows a selection of menu items in the category ‘Beers’. These menu items may have been added to the venue menu from the master menu, for example. Screen 602 shows a selection of menu items in the category ‘Cocktails’. These menu items may have been added to the venue menu based on a corresponding online venue menu discovered by a web crawler, as described in paragraph [0052], for example. The user selects menu items to be added to the order. The user may select a quantity of a selected menu item to be added to the order. If, for example, the menu item is a beverage and the beverage type is wine/champagne/spirit, the user is given an option to select as shot/glass/mixer or bottle. For example, the user may be presented with screens 603 and 604 as illustrated in FIG. 6B. Screens 603 and 604 show a selection of menu items in the category ‘Spirits’. As shown in screen 603, when a menu item is selected a user may be presented with options to further customise the menu item order, for example including a double quantity of a spirit and adding a mixer to the spirit. The current order contents and price may be presented to the user, as shown in screens 603 and 604. The user submits the order and the order is passed to electronic device 101 for processing. The order is assigned a unique order identifier and is stored in a central database with a temporary order number. The user is taken to an order summary section of the user interface to view processing or watch the “stream”/“pour”. Background and foreground functions will conduct periodic requests to electronic device 101 to update and fetch the current order status and details for presentation within the stream. The customer may be notified that a staff member is tending to their order, and may be able to view details of the staff member. For example, the user may be presented with screens 605 and 606 showing the order status as illustrated in FIG. 6C. In screen 605 the order is shown as pending. In screen 606 the order is shown as accepted and details of the staff member preparing the order are displayed along with the option to add a gratuity (tip). The user may be able to save the gratuity amount so that it is applied to future orders.

The user can be notified of any stock changes and any modifications to the order during processing. For example, if a menu item in the order is out of stock, the user may be notified and requested to modify the order (which may comprise cancelling the order) or to accept a suggested modification to the order contents and/or price.

The order will be set as ready when ready for collection. This action may initiate a notification and a request for payment from the customer and may start a countdown until an automatic payment is actioned and the order is terminated. For example, there may be a timeout of a predetermined time period (for example 15 minutes) from an order being ready to first reminder request for payment and further timeout of a predetermined time period (for example 15 minutes) until the order is automatically charged and terminated. For example, the user may be presented with screens 607 and 608 as illustrated in FIG. 6D. In screen 607 the order is shown as ready and the user is presented with payment method options to select from. In screen 608 the order is shown as ready and the user is presented with interface elements to show to the staff member to obtain their order and to mark the order as collected. It will be appreciated that the request for payment could be transmitted at various points in the order process. For example, the user may be prompted to set up the payment (e.g. select payment method, add gratuities etc.) when the order is marked as accepted, and the payment itself may be triggered when the order is marked as completed.

Once the order is identified as collected the user may be returned to the menu section of the user interface where subsequent orders may be placed.

Historical orders placed by the user may then be viewed from within a user account section of the user interface.

Processing the order may comprise adding the order to a pending order stream, receiving a user input to change the status of the order, and updating the order status. The processing may be performed at the electronic device 101. The order status may be changed (for example to ‘accepted’) by a user when they begin to prepare the order and an accepted status may prevent the order from being accepted by other users. The order status may be visible to the user that placed the order. The order status may be changed (for example, to ‘ready’) when the order is ready for collection. This may initiate a notification to the user that placed the order, which may contain a request for payment. The notification may be delivered as an SMS message or may use the native notification system of the user's electronic device 100. In some embodiments, the request for payment may occur at a different point, for example when the order is marked as accepted. The order status may be changed (for example, to ‘paid’) once payment has been received. The order status may be changed (for example, to ‘completed’) to remove the order from the pending order stream and store it in an order history. In some embodiments, payment for the order may be triggered when the order is marked as completed. In some embodiments, payment may be automatically triggered after a predetermined time period from the order being marked as ready for collection. The user may be informed of this predetermined time period when placing the order. The order histories from registered venues may provide order data, sales data, price data, etc. on which the predetermined conditions for generating the starter menu may be based.

Payment may be processed within the system, for example, using payment card details provided by the customer, and/or may be processed using an external payment provider with which the venue and/or customer have accounts. For example, when payment is requested, a user may be directed to a third-party site or module within the application to complete the payment via the third-party payment provider. A customer's payment details may be stored as constants within the application environment on the customer's electronic device.

From the pending order stream an order, or an individual menu item within an order, may be marked as ‘out-of-stock’, which may mark the menu item on the venue menu as out-of-stock and prevent further orders of that menu item until the ‘out-of-stock’ marker is removed.

Processing the order may comprise determining if the order has a user flag. The user flag may comprise a user-selected indication that the user requests the order to be processed in a particular way. For example, a user may indicate that the order should be prioritised, which may cause the order to rise to the top of the pending order stream to be processed before existing pending orders. The user flag may affect the price of the order. For example, a prioritised order may add a queue jumping fee to the price of the order. Alternatively, user flags may be separately purchased or credited to users and stored in the user's account to be added to orders when required.

Processing the order may comprise determining if the order has a gratuity. The gratuity may be a monetary amount to be added to the price of the order. Determination that an order has a gratuity may trigger a user flag to be added to the order. For example enabling of a pre-set gratuity amount may also enable prioritised status for the customer's order and orders may be prioritised according to the gratuity amount of each order.

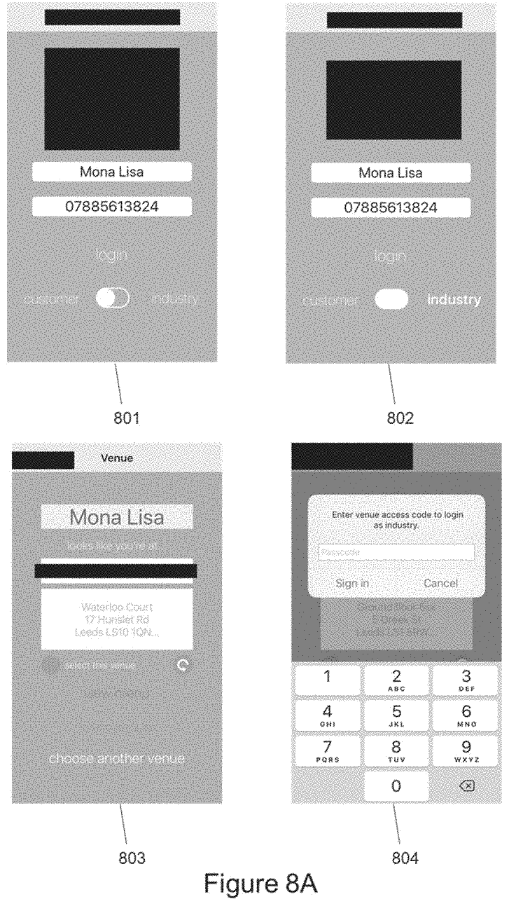

FIG. 7 illustrates a process flow for placing and processing an order according to an example of the disclosure. In FIG. 7, electronic device 100c belongs to a customer-type user (i.e. a user has logged into the application as a customer on electronic device 100c) and electronic device 100b belongs to a staff-type user (i.e. a user has logged into the application as staff on electronic device 100b). At 701 the customer creates an order at electronic device 100c. At 702 electronic device 100c transmits the order to electronic device 101. At 703, electronic device 101 adds the order to the order stream, and the updated order stream is transmitted to electronic device 100b and electronic device 100c. Although FIG. 7 shows the updated order stream being transmitted when an update occurs, it will be appreciated that this and subsequent updates to the order stream may alternatively or additionally be transmitted at periodic intervals, and/or in response to requests for updates from individual devices. At 704, the staff member accepts the order at electronic device 100b and the order status change is transmitted to electronic device 101. At 705, electronic device 101 updates the order status in the order stream, and the updated order stream is transmitted to electronic device 100b and electronic device 100c. At 706, the staff member marks the order as ready at electronic device 100b and the order status change is transmitted to electronic device 101. At 707, electronic device 101 updates the order status in the order stream, and the updated order stream is transmitted to electronic device 100b and electronic device 100c. At 708 electronic device 100c notifies the customer that the order is ready and prompts the customer to complete payment. At 709 the customer completes payment using electronic device 100c and payment is confirmed at electronic device 101. At 710, electronic device 101 updates the order status to ‘paid’ in the order stream, and the updated order stream is transmitted to electronic device 100b and electronic device 100c. At 711, the staff member marks the order as completed at electronic device 100b and the order status change is transmitted to electronic device 101. At 712, electronic device 101 removes the completed order from the order stream and the updated order stream is transmitted to electronic device 100b and electronic device 100c. At 713 electronic device 101 stores the completed order in the order history. It will be appreciated that the above order is exemplary and that, for example, the payment could be performed at various points in the order process. For example, the user may be prompted to set up the payment (e.g. select payment method, add gratuities etc.) when the order is marked as accepted at 704, and the payment itself may be triggered when the order is marked as completed at 711.

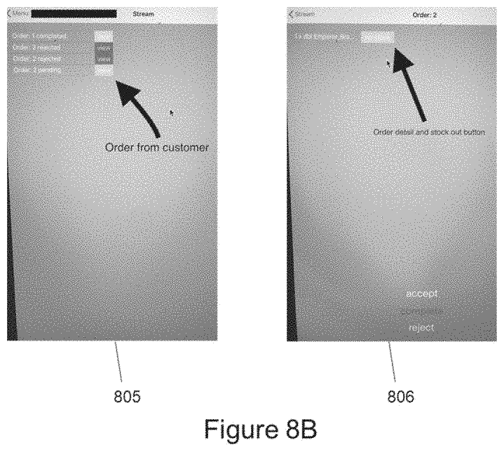

An application flow according to an example of the disclosure is now described from the perspective of a staff-type user. FIGS. 8A and 8B illustrate example screens that may be displayed on the staff member's device.

The user installs and launches the application on electronic device 100 and is assigned a unique device identifier taken from electronic device 100. The user selects staff as their user type which is stored as a constant and is used to determine the particular application interface that is presented to the user when launching the application in future. The user may be prompted to set up account details, for example profile details to be viewable by customers or a user menu. When setup is complete, or when the user subsequently launches the application and logs into their account (which may be automatic if the user's login details are stored at electronic device 100) the system identifies a venue, determines if the venue is a registered venue, and presents, if the venue is a registered venue, a prompt to enter venue access code to sign in as staff for the venue and start a shift. For example, the user may be presented with screens 801 to 804, as illustrated in FIG. 8A. In screen 801 a user may be presented with a login screen to enter their details, e.g. user name and/or phone number, and to select a user type. In screen 802 the user has selected ‘industry’ as a user type. In screen 803 the application has determined the user's location to identify a venue and has presented the identified venue for selection along with options to view the venue menu, claim the venue (for venue managers) or choose another venue. In screen 804 the user has selected a venue and is prompted to enter a venue access code to log into the venue as an industry user.

The user is presented with the application “stream” or “pour” section wherefrom orders can be accepted and processed. For example, the user may be presented with screens 805 and 806 as illustrated in FIG. 8B. When accepted, a customer may be notified of the staff member tending to their order and the selected order is guarded from acceptance by other staff members to prevent process replication. Background and foreground functions will conduct periodic requests to electronic device 101 to update and fetch the current order status and details for presentation within the stream. The user may mark individual menu items as out of stock, forcing temporary “freezing” of the menu item to prevent future requests. In screen 805 the user is presented with recent orders marked as completed, rejected or pending. In screen 806 the user has selected an order to see the order details and is presented with options to mark individual menu items as out of stock as well as options to accept, reject, or complete the order.

The user may mark the order as ready when the order is ready for collection. This action may initiate a notification and a request for payment from the customer and may start a countdown until an automatic payment is actioned and the order is terminated.

Historical orders processed by the user may then be viewed from within a user account section of the user interface.

A staff-type user may be authorised by a venue manager to access certain setup functions of the application, such as menu editing functions for the registered venue. For example, the user may be authorised to edit menu item details. The system may serve the user with pre-populated editable text fields within a table supported by a runtime database that is then sent to the electronic device 101 for storage.

The user may be authorised to add new menu items to the venue menu. For example, the user may add new menu items by utilising barcode scanning protocols native to the camera capabilities of electronic device 100 or may enter menu item details manually.

A staff-type user may also have access to the order placing functions of a customer user, as described above (e.g. for testing purposes or placing orders for themselves).

The methods described herein may further comprise identifying a user, determining if the user has an associated user menu comprising at least one user menu item, and adding, if the user has an associated user menu, at least one user menu item to the menu associated with the venue. For example, a staff-type user may create a user menu comprising user menu items, such as cocktails the user has invented or is skilled at making. These user menu items may be added to a venue menu when the user logs on as a staff-type user for that venue. This inclusion of the user menu items on the venue may be temporary. That is, the user menu items may only be included in the venue menu when the user is logged on as a staff-type user for that venue and/or is determined to be physically present at that venue. For example, the methods may further comprise determining if the user is at the venue, and removing, if the user is not at the venue, the at least one user menu item from the menu associated with the venue. The user may be determined to have left the venue based on, for example, location data of the user's electronic device 100, if the user logs out of the application, if the user logs on as a staff-type user at another venue, or any other suitable technique.

The application may utilise social networking or integrate with existing social network platforms to enable logging statistics and to enable customers to see if their contacts are currently logged into a registered venue. Users may be enabled to order menu items for their contacts at registered venues.

The application may enable a user to view accounts of other users in the same venue and to place orders to be sent to another user in the same venue.

The application may incorporate customer and venue count statistics to determine the number of customers that are using the application at a particular venue to estimate the number of people at the venue. For example, a user may be able to view a list or visual representation of nearby venues showing an estimated number of people at each venue or estimated level of fullness of each venue.

The application may use a server-side function to notify a staff member or master device of a venue of any newly received data that is appropriate to the user's current rendering of the application. Such updates may include, but are not limited to, notification of new orders received at the venue, promotions or promotional codes set by the venue, job vacancies at venues, order status, etc.

Customer-type users may be able to set a ‘virtual tab’ with which limits on spending/usage can be placed for a set time or a set number of venues or after a set spend, alcoholic unit consumption, or calorie consumption, for example.

The application may incorporate a function that determines variables representing the times between the different states of an order. The function will listen for change of these variables, compare them to preset values and serve an appropriate response. For example, if the function determines the order status has taken longer than a certain preset time to be updated to the subsequent/next order status, a variable is created noting the time discrepancy and an output can presented to the appropriate user. For example, reductions to gratuities or order prices may be applied to orders not delivered or completed within a set time.

The application may comprise a computer program comprising instructions arranged, when executed, to implement any of the methods described herein. A machine-readable storage may store such a program.

It will be appreciated that embodiments of the present invention can be realized in the form of hardware, software or a combination of hardware and software. Any such software may be stored in the form of volatile or non-volatile storage, for example a storage device like a ROM, whether erasable or rewritable or not, or in the form of memory, for example RAM, memory chips, device or integrated circuits or on an optically or magnetically readable medium, for example a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium, for example a communication signal carried over a wired or wireless connection and embodiments suitably encompass the same.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. It will be also be appreciated that, throughout the description and claims of this specification, language in the general form of “X for Y” (where Y is some action, activity or step and X is some means for carrying out that action, activity or step) encompasses means X adapted or arranged specifically, but not exclusively, to do Y.

The reader's attention is directed to all papers and documents which are filed concurrently with or previous to this specification in connection with this application and which are open to public inspection with this specification, and the contents of all such papers and documents are incorporated herein by reference.

1. A method of operating an electronic device, the method comprising:
registering a new venue; and
associating a starter menu to the registered venue;
wherein the starter menu comprises at least one menu item selected from a master menu according to at least one predetermined condition, the master menu comprising menu items included in at least one menu associated with at least one other registered venue.

2. The method of claim 1, further comprising:
identifying a venue; and
determining if the identified venue is a registered venue;
wherein if the identified venue is not a registered venue, registering a new venue comprises registering the identified venue.

3. The method of claim 2, wherein if the venue is a registered venue, the method further comprises:
receiving a user input to add a new menu item to a menu associated with the registered venue; and
adding the new menu item to the menu associated with the registered venue and to the master menu.

4. The method of claim 1, wherein adding a new menu item to a master menu comprises:
determining if the new menu item already exists on the master menu; and
adding, if the new menu item does not already exist on the master menu, the new menu item to the master menu.

5. The method of claim 4, wherein receiving a user input to add a new menu item to a menu associated with the registered venue comprises receiving an input of at least one of an image input, a text input, a file input, or a selection of at least one menu item from a list of suggested menu items.

6. The method of claim 1, further comprising:
receiving a user selection of a menu item on a menu associated with the registered venue; and
receiving a user input to edit the menu item.

7. The method of claim 1, wherein the at least one predetermined condition comprises at least one of number of sales in other registered venues, frequency of inclusion in menus associated with other registered venues, profitability, ingredients, allergens, price, manufacturer or origin.

8. The method of claim 1, further comprising:
using a web crawler to find online venue menus;
extracting one or more menu items from the found online venue menus; and
adding the extracted menu items to the master menu.

9. The method of claim 8, wherein registering a venue comprises determining if an online venue menu of the venue has previously been found;
wherein, if an online venue menu of the venue has previously been found, the starter menu includes menu items extracted from the found online venue menu; and
wherein if an online venue menu of the venue has not previously been found, the method further comprises:
searching for an online venue menu of the venue;
extracting, if an online venue menu of the venue is found, one or more menu items from the found online venue menu; and
adding the extracted menu items to the starter menu.

10. The method of claim 1, further comprising:
receiving an order of a menu item selected from the menu associated with the registered venue;
processing the order; and
updating the master menu with order data associated with the order.

11. The method of claim 10, wherein processing the order comprises:
adding the order to a pending order stream;
receiving a user input to change the status of the order; and
updating the order status.

12. The method of claim 1, wherein the method further comprises:
identifying a user;
determining if the user has an associated user menu comprising at least one user menu item; and
adding, if the user has an associated user menu, at least one user menu item to the menu associated with the venue.

13. A machine-readable storage storing a computer program comprising instructions arranged, when executed, to implement the method of claim 1.

14. An electronic device configured to:
register a new venue; and
associate a starter menu to the registered venue;
wherein the starter menu comprises at least one menu item selected from a master menu according to at least one predetermined condition, the master menu comprising menu items included in at least one menu associated with at least one other registered venue.

15. The electronic device of claim 14, wherein the electronic device is further configured to:
identify a venue; and
determine if the identified venue is a registered venue;
wherein if the identified venue is not a registered venue, registering a new venue comprises registering the identified venue.

16. The electronic device of claim 15, wherein the electronic device is further configured to:
receive, when identifying a venue, venue identification information from another electronic device; and
determine if the venue is a registered venue based on the venue identification information.

17. The electronic device of claim 14, wherein the electronic device is further configured to:
transmit, when registering the new venue, a request for venue registration details to another electronic device;
receive the venue registration details from the other electronic device; and
register the new venue based on the registration details.

18. The electronic device of claim 14, wherein the electronic device is further configured to transmit the starter menu to another electronic device.

19. The electronic device of claim 14, wherein the electronic device is further configured to:
receive a request from another electronic device to add a new menu item to the menu associated with the registered venue; and
add the new menu item to the menu associated with the registered venue and to the master menu.

20. The electronic device of claim 19, wherein the electronic device is further configured to:
determine, when adding the new menu item to the master menu, whether the new menu item already exists on the master menu; and
add, if the new menu item does not already exist on the master menu, the new menu item to the master menu.
